(19) United States
(12) Patent Application Publication
(10) Pub. No.: US 2015/0071123 A1
(43) Pub. Date: Mar. 12, 2015

(54) INTEGRATING SOFTWARE DEFINED STORAGE AND SOFTWARE DEFINED NETWORKING

(71) Applicant: Brocade Communications Systems, Inc., San Jose, CA (US)

(72) Inventor: Amr Sabaa, Sunnyvale, CA (US)

(21) Appl. No.: 14/481,543

(22) Filed: Sep. 9, 2014

Related U.S. Application Data
(60) Provisional application No. 61/876,145, filed on Sep. 10, 2013.

(51) Int. Cl. H04L 12/24; H04L 29/08

(52) U.S. Cl. CPC H04L 41/042; H04L 41/12; H04L 67/1097; H04L 41/5038
USPC 370/255

(57) ABSTRACT

A coordination task to interface with VM, SDS and SDN environments to guarantee that the overall QoS of the combined SDN and SDS meet desired levels. The coordination task performs this coordination when virtual targets are originally developed, when the virtual targets are modified and when the accessing servers are reconfigured, such as when a VM moves.

### RELATED APPLICATIONS

This application is a non-provisional application of Ser. No. 61/876,145, titled “Integrating Software Defined Storage and Software Defined Networking,” filed Sep. 10, 2013, which is incorporated herein by reference.

### TECHNICAL FIELD

The invention relates to networked devices and storage devices, and in particular to integrating software defined storage and software defined networking.

### BACKGROUND

Cost of traditional storage area network (SAN) and network attached storage (NAS) arrays is high because of the need for custom hardware and custom operating systems that are used in these arrays. Networking solutions that can use standard hardware avoid the high cost associated with these arrays. One solution that utilizes standard hardware is Software Defined Storage (SDS).

SDS uses standard x86 hardware and standard operating systems (OS) to provide the required functionality. This means that with improvements of the server speed and storage capacity, the solution can provide bigger storage without the need to manufacture new arrays. Another advantage of using standard hardware is the ability to scale a storage system by simply adding more servers, as with web servers.

By using standard servers, SDS provides the ability for rapid deployment as a result of changes in the business requirements. SDS allows a user to deploy a storage solution in a very short time compared to the time needed to deploy and configure SAN or NAS. Thus SDS allows easy redistribution of storage based on business needs, while in traditional SAN and NAS more work is involved. Additionally, with SDS it is software, not hardware that provides the resilience of the solution. Thus, for example if a server fails, software recovers from the failure and uses the server to provide the needed functionality. Accordingly, there is clear value in using a SDS solution that utilizes standard servers for storage systems. Currently some databases, web servers and applications use this type of hardware to store their data.

Software-defined networking (SDN) is introduced to decouple data path switching from routing decision making. In SDN, a software application running in a controller can make a decision about what should be done for the packets between a specific source and destination. The hardware in turn will do the packet switching.

This is very different from the way routing is performed in a traditional network. In conventional networks, when a packet arrives at a switch, the switch will make the routing decision based on rules built into the switch. Thus, the switch sends every packet going to the same destination along the same path based on rules that are already defined and cannot be dynamically changed. In the enterprise, smart switches are sophisticated enough to recognize different types of packets and treat them differently, but such switches can be quite expensive. Thus, by using a SDN, routing can be decided and performed dynamically.

SDN also allows network engineers and administrators to respond quickly to changing business requirements and network states. In SDN, a network administrator can put in place a rule to define a packet route from a centralized control console without having to touch individual switches. The administrator can also set up rules for reacting to changes in the network condition. This is important to minimize the response time for any failure or changes in the network conditions. It allows the administrator to manage traffic loads in a flexible and more efficient manner. Thus, there is clear value in using a SDN solution.

One of the challenges for SDS is to be able to serve all the different users/applications in a secure manner without them affecting one another. Another difficulty is to meet the different requirements for Quality of Service (QoS) that different users have. Different server and storage arrays provide different Input/Output Operations Per Second (IOPs) and different latencies for read and write operations. Thus, in SDS, the physical storage will be selected based on the QoS needed, but this is not enough to guarantee the QoS required by the user.

The actual QoS seen by the user is not just the storage QoS; it also includes the network QoS. The network connection between the user and the storage plays a big role in defining the QoS that the user will see. For example, if a physical storage unit with high QoS is assigned to a user but the network path between the user and the physical storage is congested, the user will see low QoS for this storage.

Thus, in SDS, the QoS is not just the QoS provided by the storage array or the server. It is the QoS experienced by the user which can be different and is highly dependent on the network path between the user and the storage arrays/servers. It is important to insure the QoS experienced by the user meets the user's requirement throughout its use.

### SUMMARY OF THE INVENTION

A coordination task is provided to interface with the virtual machine (VM), SDS and SDN environments to guarantee that the overall QoS of the combined SDN and SDS meet desired levels. The coordination task performs this coordination when virtual targets are originally developed, when the virtual targets are modified and when the accessing servers are reconfigured, such as when a VM moves.

### BRIEF DESCRIPTION OF THE FIGURES

The accompanying drawings, which are incorporated in and constitute a part of this specification, illustrate an implementation of apparatus and methods consistent with the present invention and, together with the detailed description, serve to explain advantages and principles consistent with the invention.

FIG. 1 is a block diagram of an exemplary network and virtual storage according to one embodiment of the present invention.

FIG. 2 is a block diagram of a network including a plurality of servers incorporating virtual machines, plurality of management workstations and a switch according to one embodiment of the present invention.

FIG. 3 is a flowchart of the integration operations according to one embodiment of the present invention.

### DETAILED DESCRIPTION OF THE PREFERRED EMBODIMENTS

One of the issues to consider when using SDS to provide storage capacity for a network is how to guarantee the QoS required by a user. As discussed above, in an SDS environment the QoS experienced by the user is affected by not just the storage QoS, but also the network path between the user and the storage device. Thus, a solution is disclosed herein that meets the user's QoS requirements by providing integration between SDS and SDN.

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

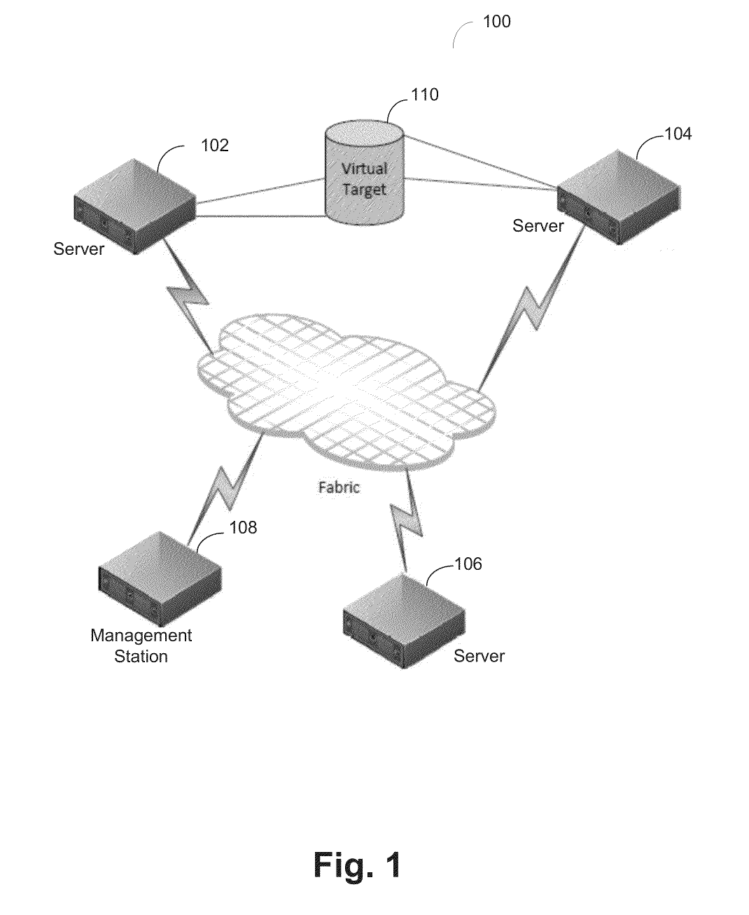

Referring to FIG. 1, a network environment 100 which includes three servers is illustrated. The servers include server 102 and server 104 which, in one embodiment, both include internal storage that can be used to create virtual storage. Storage space in each server can be designated as a separate virtual target. Alternatively, as illustrated in FIG. 1, the internal storage of two servers may be combined to create a virtual target 110. In general, virtual storage can be defined as part of multiple storage arrays or multiple servers. These arrays or servers can be connected to different switches or located in different locations. It must be noted that part of creating the virtual target is to set the routing in the network and the priority of the traffic to guarantee a required bandwidth.

Once developed, the virtual target can be accessed by one of the servers that hosts the backend of the virtual target, or by another server or host computer. The virtual target can be presented as a virtual block device, file or object. The backend storage for the virtual target can be physical block storage, filer or object storage. It also can be virtual block storage, filer or object storage. A virtual target may also be mirrored. There can be different QoSs for each mirror and the network can be configured based on those different QoSs.

A third server, server 106, in the network environment may desire to access the virtual target 110. Assuming that server 106 has a specific QoS requirement for the virtual target 110, the solution integrates SDS and SDN to ensure the QoS requirement is met. This is done, in one embodiment, by first ensuring that the virtual target has a sufficient QoS to meet the desired level. This process is done by an SDS manager (not shown), in one embodiment. The SDS manager may be housed in the management workstation 108. The L2 or L3 network or fabric between server 106 and servers 102 and 104 may be configured to guarantee the throughput required by server 106 to both servers 102 and 104. This may be done by a coordination task (not shown) which may also be housed on the management workstation 108. The coordination task works with the SDN manager, management tasks for each of the virtual machines on the servers 102 and 104 and 106, and the SDS to provide coordination between the various management tasks and guarantee the throughput.

The management workstation 108 is provided as exemplary of the management tasks for each of the servers 102, 104 and 108, the SDS, SDN and the coordination task. The various management tasks and managers may be located on one management workstation. Alternatively, the management tasks or managers may be housed on different servers or workstations. Each of the management tasks may have application programming interfaces (APIs) to allow the needed inter-task communications.

The QoS can be set using any known SDN configuration schemes or any vendor specific scheme. As discussed above, the network path to reach the virtual target 100 is essential in defining the QoS that the user will see accessing this virtual target and is thus an important aspect of setting the QoS.

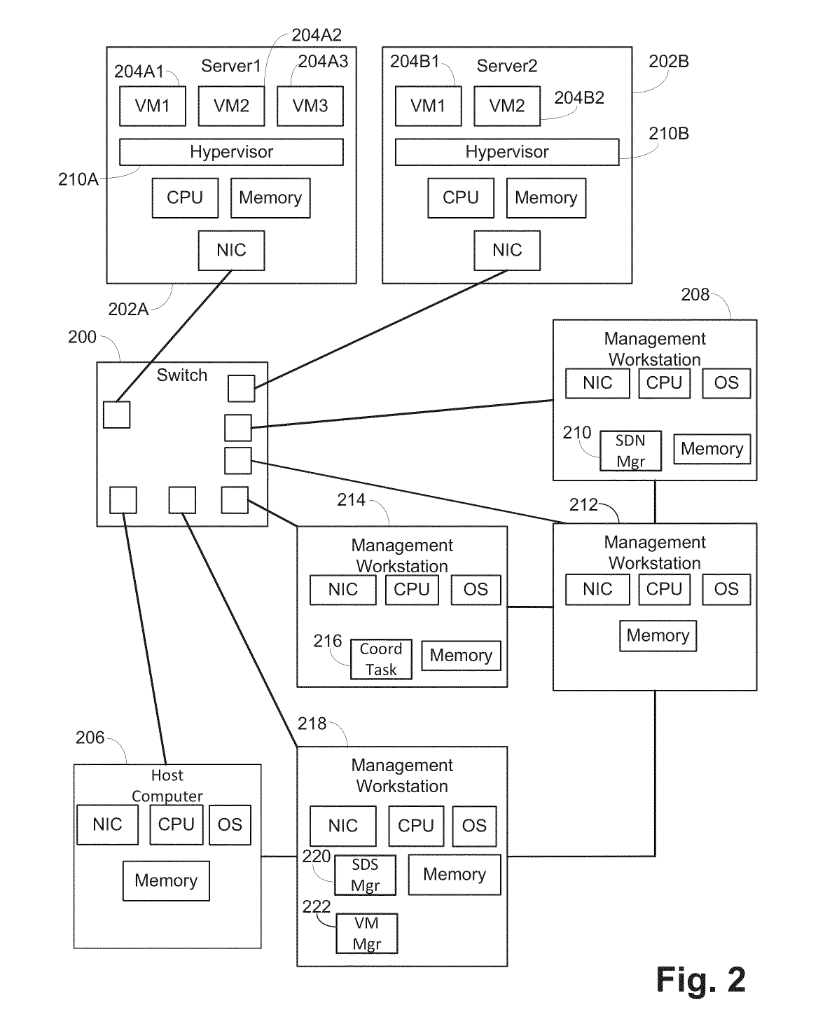

FIG. 2 illustrates an alternative networking environment 200 which may implement an integration between SDS and SDN to provide storage with a required QoS. The environment 200 includes two servers server1-server2 202A-B which are connected to different ports of a switch 200. Each server 202 has a least one virtual machine (VM) 204 executing on the server physical hardware. For example, server 202A has three VMs 204A1-204A3, and server 202B has two VMs 204B1, 204B2. The VMs can be combined or used separately to create virtual targets for storage purposes. The network environment 200 may also include one or more storage devices (not shown) connected to each of the severs server1-server2 202A-B. In one embodiment, one or more of the servers 202 are also host computers.

A host computer 206 is connected to the network through the switch 200. The host computer 206 can access the virtual target and the storage devices connected to the network through this connection. In instances where the host computer 206 has a specific QoS requirement, the specific storage used for the host computer 206 and the routing path to that storage is selected such that the QoS requirement is met. This is done by integration between various managers and management tasks.

The storage spaces available on the network for use by the host computer 206 may include storage from one or more of the servers, host computers, or other devices on the network, but may appear as one virtual target to the user. For example, the storage may include direct connected disk drives of one or more host computers. Storage space in servers can be used for virtual storage, as a server can provide its local storage to provide virtual storage that is accessed by other hosts at the same time as the same server is used for providing computing power for some applications. The network interface for such a server will be carrying application traffic in addition to the storage traffic. The two types of traffic may affect each other, resulting in a less than expected storage QoS for the user. In such a case the storage traffic is generally given priority over the application traffic to satisfy the required QoS. However, because this is not always possible, part of the selection of the server that forms the virtual target is based on whether the server can provide the storage traffic with the needed priority. Thus, to develop a virtual target for a user, the network environment provides a variety of management tasks that work together to select storage spaces in servers and computers that can satisfy the host computer's QoS needs.

The network environment 200 includes a management workstation 218 connected to the host computer 206 through the switch 200 and containing an SDS manager 220. The SDS manager is used to identify available storage resources and detect their QoS. In this embodiment, the SDS manager 220 analyzes storage space available at VMs of the servers 202 and storage available in any other storage device connected to the environment 200 to determine which storage device, virtual storage, or combination provides the QoS requested by the host computer 206.

The management workstation 218 also includes a VM manager 222 which is connected through the switch 200 to the host computer and to the VMs in each of the servers 202A and 202B for managing those VMs.

Once it is determined which storage options provide the required QoS, the SDS works with a coordination task 216 housed at a management station 214 to ensure that the proper storage option is selected and the correct path to the selected storage option is mapped. To achieve this, the SDS manager 220 is connected (through the switch 200 and the management workstation 218) to the management workstation 214 which contains the coordination task 216 that coordinates the task of satisfying the QoS requirements for the users.

To perform its functionality, the coordination task 216 is connected (through the management workstation 214) to a management workstation 208 which contains an SDN manager 210. The SDN manager 210 is used to configure, manage, secure, and optimize network resources. In one embodiment, once storage options providing a required QoS are selected, the coordination task 216 works with the SDN manager 210 to determine routing of packets through the network fabric. The SDN manager 210 sets up a path through the network fabric with a QoS associated with the path from the host computer to the selected storage option that satisfied the user's QoS requirements.

As such, the coordination task 216 works with the SDN manager 210, the SDS manager 220 and the VM manager 222 to provide integration between the VMs, SDN and SDS and offer the QoS required by the user for accessing a virtual target or storage device. When a change is made to the network environment, the coordination task works with the appropriate management task to ensure that the QoS requirements continue being met. For example, if a VM is moved from one server to another server or a host computer, the coordination task 216 operates with the VM manager 222 to insure that the overall desired QoS is still available at the host computer 206.

In one embodiment, the SDN manager 210 is connected to a management workstation 212 which allows an administrator to manage the SDS and the SDN. The management functions may be performed by remote login into the SDN and SDS managers. Alternatively, a direct interface may be available at each of the workstations 208 and 218 for managing the SDS and the SDS. In another configuration, an internet interface is used to manage one or both these managers.

In one embodiment, the solution may have one or more management servers that are located somewhere in the network. These servers communicate with the other server to provision storage, to have health check heartbeat or for some other reasons. The path between these management servers and the storage server is configured to guarantee the bandwidth needed for the management tasks.

In order to determine routing of packets to achieve a specific QoS, in one embodiment, traffic flow across the various ports in the network may need to be measured. This can be through the use of port processors and packet counters, as is well known in the art.

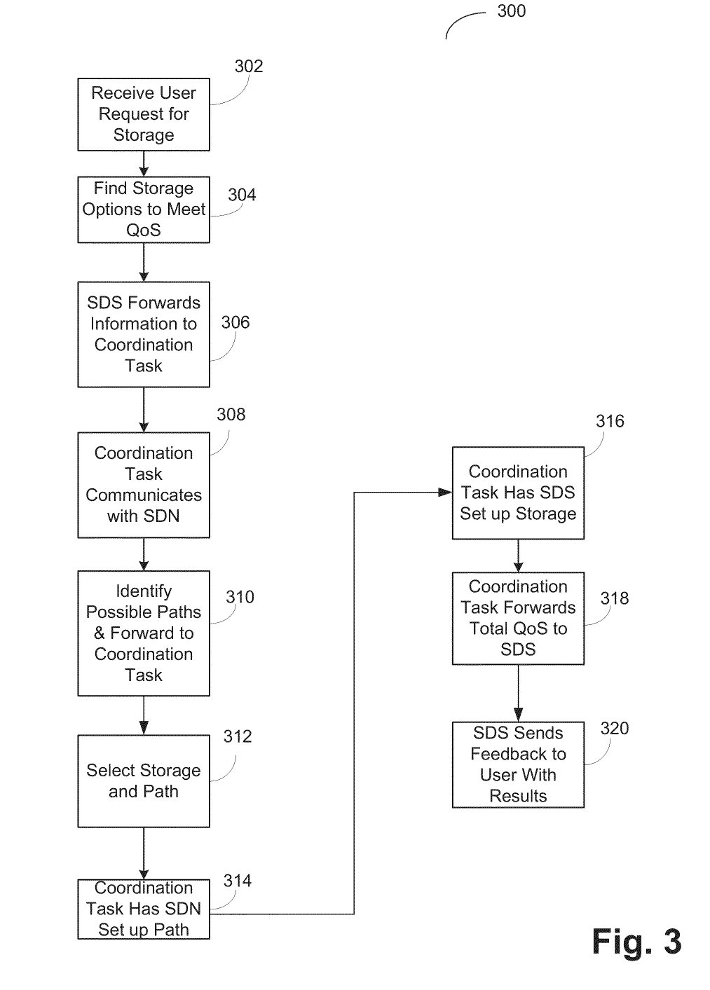

FIG. 3 is a flowchart of the operation 300 for assigning storage space to a user and developing a network path that assures the user's QoS requirements are met. Operation 300 begins, in one embodiment, at step 302 by receiving a request for storage from a user. In one embodiment, this request includes the user's QoS requirement and is sent through the network to the SDS manager 220 for fulfillment.

The SDS manager 220 then analyzes the storage space available on the network to find, at step 304, storage options that meet the QoS requirement. This information along with the required QoS is then sent, at step 306, by the SDS manager 220 to the coordination task 216 to coordinate configuring a path to the storage space that satisfies the QoS requirement.

Upon receiving the information, the coordination task 216 communicates with the SDN manager 210, at step 308, to forward the required QoS and request that network paths that satisfy the requirement be identified. The SDN manager 210 then analyzes the network to identify all network paths to the available storage spaces that satisfy the required QoS and forwards the information to the coordination task 216, at step 310.

The network path can be configured using any SDN scheme supported by the network. It can also be configured using the network configurable command line interface (CLI) or can be configured manually. Virtual Channel (VC) crediting between the different QoSs on the server and the connected switch can be used to guarantee the bandwidth needed by the storage system. Other priority schemes can be implemented in the network stack to provide the storage traffic with the required priority. For example, back pressure can be applied to network traffic if the network sent queue exceeds certain limits before it is applied to storage traffic.

The coordination task 216 selects a proper storage configuration and path that satisfies the requirements, at step 312. This information is sent by the coordination task 216 to the SDN manager 210 to request that the SDN manager 210 set up a path to the selected storage configuration that satisfied the QoS requirement, at step 314. The coordination task 216 then forwards the total QoS to the SDS manager 220, at step 318. In response, the SDS manager 220 sends feedback to the user with the results, at step 320.

In one embodiment, once storage has been configured and network paths are developed, the system, the operation continues monitoring the devices to ensure no changes in the network affect the required QoS. For example, the operation may monitor to detect if a server or VM that forms the storage has moved. If a move is detected, the network reacts to the move, and the SDN manager 210 and the coordination task 216 adjust the network path based on the move to ensure that the QoS is not changed. For example, if a VM forms part of the virtual target and this VM moves to a new server, the QoS path is reconfigured by the coordination task 216 in concert with the VM manager 222, the SDS manger 220 and the SDN manager 210 to provide the required overall QoS based on the new location of the VM. The network path is also updated if the server or the VM that accesses the virtual target goes offline or comes online.

In one embodiment, the operation also determines if any of the servers or host computers that form part of the virtual target have experienced a failure. When a failure is detected, the storage system generally recovers by serving the IOs from one of the mirrors that contain data lost as a result of the failure. In one embodiment, one of these mirrors is used to make another copy of the data that was hosted by the failed server. This data may end up residing in a new server or new host computer. In such a case, the network path to access the storage location may need to be adjusted to ensure the required QoS. As such, the operation checks to determine if the storage space used for the lost data is at a new location. When the storage space is at a new storage device, the path between the servers and host computers that will access this data and the new storage device that hosts part of the virtual target is configured by the SDN manager 210 and the coordination task to guarantee the required QoS.

Additionally, in one embodiment, the operation monitors the network to determine if there has been a change in size of one or more servers or host computers that make up the virtual target. That is because increasing or decreasing the size of a virtual target can result in using the backend from another server that was not used before for that virtual target. For example, when additional storage devices are used to provide an enlarged virtual target, the network path may need to be reconfigured. If a new device is used, the network path is configured again to ensure the QoS requirements are met. Thus, the coordination task 216 may in cooperation with the SDS and SDN managers 210 and 220 update the QoS path to access the virtual target.

As discussed above, satisfying QoS requirements of users is important in a network, particularly since a storage device is considered to be first tier device only if the physical device can satisfy the QoS requirements and the network path between the user and this device also satisfies the QoS requirements. To ensure these requirements are met, the operations discussed in this disclosure make use of the SDN manager, SDS manager, VM manager and a coordination task to assign storage spaces to a virtual target that satisfy the QoS requirement and then configure network paths to the virtual target and the storage devices that ensure the QoS requirements are met.

The above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A management workstation comprising:
a processor; and
a memory;
wherein said memory includes a coordination task executable by said processor to:
coordinate with a software defined storage (SDS) manager to configure a virtual target formed from at least one of one or more storage devices for access by a host computer in a network, the virtual target configured to appear as at least one virtual target to the host computer, with a quality of service (QoS) associated with the at least one virtual target; and
coordinate with a software defined network (SDN) manager to develop a path through the network from the host computer to each of at least one of the one or more storage devices in the virtual target for routing of packets, with a QoS associated with the path; and
coordinate the QoSs of the at least one of the one or more storage devices, the virtual target, and the path to meet an overall desired QoS.

2. The management workstation of claim 1, wherein at least one of the one or more storage devices is a direct connected disk drive of a host computer.

3. The management workstation of claim 1, wherein when a size of the at least one virtual target is changed, the coordination task further operates to insure that the overall desired QoS is available at the changed virtual target.

4. The management workstation of claim 1, wherein when at least one of the one or more storage devices that appear as the virtual target fails, the coordination task further coordinates with the SDS manager to replace the failed storage device with one or more other storage devices to appear as at least a changed virtual target and to insure the overall desired QoS is available at the changed virtual target.

5. The management workstation of claim 4, wherein the coordination task further coordinates with the SDS manager to insure that the overall desired QoS is available at the changed virtual target when the replaced storage device is a device that did not originally appear as at least one virtual target.

6. The management workstation of claim 1, wherein the coordination task further operates to insure that the desired QoS is met, when a virtual machine (VM) is moved from a first one of the one or more storage devices to a second one of the one or more storage devices.

7. A network comprising:
at least one server, each server including:
a processor;
at least one storage device; and
a memory;
said at least one storage device including software executed by said processor to cause at least some capacity of said at least one storage device to be available to one or more external devices as Software Defined Storage (SDS);
a host computer for accessing said SDS;
a plurality of storage devices;
a network fabric interconnecting said at least one server and said host computer;
an SDS manager coupled to said at least one server and said host computer to cause said at least some capacity of said at least one storage device to appear as at least one virtual target to said host computer, with a quality of service (QoS) associated with said at least one virtual target;
a software defined network (SDN) manager coupled to said network fabric to determine routing of packets through said network fabric, with a QoS associated with a path from said host computer to said at least one server providing capacity in said virtual target; and
a coordination task coupled to said SDS manager and said SDN manager to coordinate the QoSs of said at least some capacity of said at least one storage device, said virtual target and said path to meet an overall desired QoS.

8. The network of claim 7, further comprising a management workstation, said management workstation including a memory wherein the SDS manager is stored.

9. The network of claim 7, further comprising a management workstation, said management workstation including a memory wherein the SDN manager is stored.

10. The network of claim 7, further comprising:
a second server; and
a virtual machine (VM) manager coupled to said coordination task, said at least one server and said second server, both said at least one server and said second server having at least one VM executing thereon;
wherein when a VM is moved from said at least one server to said second server, said coordination task operates to insure that the overall desired QoS is available at said second server.

11. The network of claim 7, wherein when a size of the at least one virtual target is changed, the coordination task operates to insure that the overall desired QoS is available at the changed virtual target.

12. The network of claim 7, wherein when said at least some capacity of said at least one storage device fails, said SDS manager operates to replace said at least some capacity of said at least one storage device fails with one or more other capacity of said at least one storage device and to include said replaced at least some capacity of said at least one storage device as part of a changed virtual target, wherein the SDS manager operates to insure that the overall desired QoS is available at the changed virtual target.

13. The network of claim 12, wherein the SDS manager operates to insure that the overall desired QoS is available at the changed virtual target when the replaced at least some capacity of said at least one storage device is a device that did not originally appear as at least one virtual target.

14. A method for comprising:
configuring a virtual target formed from at least one of one or more storage devices for access by a host computer, the virtual target having a quality of service (QoS) value;
developing a path through the network from the host computer to each of at least one of the one or more storage devices in the virtual target for routing of packets, the path having a QoS value; and
coordinating said configuring step and said developing step to ensure that the combined virtual target QoS value and the path QoS value meet an overall QoS value desired by the host computer.

15. The method of claim 14, wherein the virtual target is configured by a software defined storage (SDS) manager coupled to the one or more storage devices and the host computer.

16. The method of claim 14, wherein the path is developed by a software defined network (SDN) manager coupled to the network.

17. The method of claim 15, wherein a coordination task coupled to the SDS manager and the SDN manager coordinates to ensure a QoS of the one or more storage devices, a QoS of the virtual target, and a QoS of the path meet the overall desired QoS.

18. The method of claim 17, wherein when a virtual machine (VM) executing on a first one of the one or more storage devices moves to second one of the one or more storage devices, the coordination task operates to insure that the overall desired QoS is available at the second one or more storage devices.

19. The method of claim 14, wherein when at least one of one or more storage devices that form the virtual target fails, the SDS manager operates to replace the failed storage device with one or more other storage devices.

20. The method of claim 19, further comprising including the replaced storage device as part a changed virtual target, and operating to insure that the overall desired QoS is available at the changed virtual target.

21. A non-transitory computer readable storage medium or media having computer-executable instructions stored therein for an application which causes a processor to perform the following method, the method comprising:
operating a coordination task which:
works with a software defined storage (SDS) manager to configure a virtual target formed from at least one of one or more storage devices for access by a host computer in a network, the virtual target having an associated quality of service (QoS);
working with a software defined network (SDN) manager to develop a path through the network from the host computer to each of at least one of the one or more storage devices in the virtual target for routing of packets, the path having an associated quality of service (QoS); and
coordinating said configuring step and said developing step to ensure the combined virtual target QoS value and the path QoS value meet an overall QoS value desired by the host computer.

22. The non-transitory computer readable storage medium or media of claim 21, wherein the coordination task is coupled to the SDS manager and the SDN manager.

23. The non-transitory computer readable storage medium or media of claim 21, wherein the coordination task further operates to insure that the overall desired QoS is met, when a virtual machine (VM) is moved from a first one of the one or more storage devices to a second one of the one or more storage devices.

24. The non-transitory computer readable storage medium or media of claim 21, wherein the coordination task further operates to insure that the overall desired QoS is met, when one of the one or more storage devices that form the virtual target fails.

25. A management workstation comprising:
a processor; and
a memory;
wherein said memory includes a software defined storage (SDS) manager executable by said processor to:
receive a request for allocating SDS for use by a host computer in a network;
coordinate with a coordination task to configure a virtual target formed from at least one of one or more storage devices for access by the host computer, the virtual target configured to appear as at least one virtual target to the host computer, with a quality of service (QoS) associated with the at least one virtual target; and
coordinate with the coordination software to ensure that the configured virtual target meets an overall QoS desired by the host computer.

26. The management workstation of claim 25, wherein at least one of the one or more storage devices is a direct connected disk drive of a host computer.

27. The management workstation of claim 25, wherein when a size of the at least one virtual target is changed, the SDS manager coordinates with the coordination task to insure that the overall desired QoS is available at the changed virtual target.
